(19) United States
(12) Patent Application Publication
(10) Pub. No.: US 2014/0184001 A1
(43) Pub. Date: Jul. 3, 2014

(54) SPINDLE MOTOR

(71) Applicant: SAMSUNG ELECTRO-MECHANICS CO., LTD., Suwon (KR)

(72) Inventor: Viatcheslav SMIRNOV, Suwon (KR)

(73) Assignee: SAMSUNG ELECTRO-MECHANICS CO., LTD., Suwon (KR)

(21) Appl. No.: 13/800,784

(22) Filed: Mar. 13, 2013

(30) Foreign Application Priority Data
Dec. 27, 2012 (KR) 10-2012-0155291

(51) Int. Cl. H02K 1/28; H02K 7/08

(52) U.S. Cl. CPC H02K 1/28; H02K 7/08
USPC 310/90

(57) ABSTRACT

There is provided a spindle motor including a shaft including a body part and an extension part extended from an upper portion of the body part in an outer diameter direction, a sleeve rotatably supporting the shaft, and a rotor rotating together with the shaft and including a stopper part facing an outer peripheral surface of the sleeve, wherein the extension part and the rotor are coupled to each other outwardly of the outer peripheral surface of the sleeve in the outer diameter direction.

### CROSS-REFERENCE TO RELATED APPLICATIONS

This application claims the priority of Korean Patent Application No. 10-2012-0155291 filed on Dec. 27, 2012, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor having improved rigidity, bearing rigidity and sealing of a lubricating fluid in a hydrodynamic bearing.

2. Description of the Related Art

A hard disk drive (HDD), an information storage device, reads data stored on a disk or writes data to a disk using a read/write head.

The hard disk drive requires a disk driving device capable of driving the disk. In the disk driving device, a spindle motor is used.

Such a spindle motor has been used in a hydrodynamic bearing assembly. A shaft, a rotating member of the hydrodynamic bearing assembly, and a sleeve, a fixed member thereof, have a lubricating fluid interposed therebetween, such that the shaft is supported by fluid pressure generated in the lubricating fluid.

In the spindle motor, miniaturization and thinness has been continuously demanded. As the motor has been thinned and miniaturized, bearing rigidity has become naturally weak.

Bearing rigidity, a main factor determining rotation characteristics of the spindle motor, is affected by an interval between dynamic pressure bearing grooves, that is, a bearing span length.

That is, the longer the bearing span length, the higher the bearing rigidity, such that the rotational characteristics of the motor may be improved. Even in the case that the motor is miniaturized and thinned, bearing rigidity should not be affected.

In addition, the lubricating fluid injected into the hydrodynamic bearing assembly may be leaked to the outside by an external impact or reduced by evaporation. Due to this phenomenon, the hydrodynamic bearing may not generate sufficient pressure, a problem in performance and lifespan of the spindle motor may be generated.

Therefore, research into technology allowing the bearing rigidity to remain unaffected while implementing miniaturization and thinness in the spindle motor and preventing leakage of the lubricating fluid to significantly increase motor performance and lifespan has been urgently demanded.

### SUMMARY OF THE INVENTION

An aspect of the present invention provides a spindle motor having improved rigidity and bearing rigidity, and miniaturization and thinness implemented therein, and preventing a lubricating fluid from leaking.

According to an aspect of the present invention, there is provided a spindle motor including: a shaft including a body part and an extension part extended from an upper portion of the body part in an outer diameter direction; a sleeve rotatably supporting the shaft; and a rotor rotating together with the shaft and including a stopper part facing an outer peripheral surface of the sleeve, wherein the extension part and the rotor are coupled to each other outwardly of the outer peripheral surface of the sleeve in the outer diameter direction.

The shaft may further include a protrusion part extended from a distal end of the extension part in an axial direction, and the extension part and the protrusion part may be coupled to the rotor.

The rotor may include a disk part coupled to the extension part, and the stopper part may be extended from the disk part.

The outer peripheral surface of the sleeve and an inner peripheral surface of the stopper part may be inclined downwardly in an inner diameter direction.

The outer peripheral surface of the sleeve and an inner peripheral surface of the stopper part may be inclined downwardly in the outer diameter direction.

The spindle motor may further include: a base member fixedly coupled to the sleeve; and a stator holder fixed to the base member and having a core seated thereon, the core having a coil wound therearound.

An outer peripheral surface of the stopper part and a surface of the stator holder opposite to the outer peripheral surface of the stopper part may include a labyrinth sealing part formed therebetween.

An outer peripheral surface of the stopper part may be stepped in an inner diameter direction, and the surface of the stator holder opposite to the outer peripheral surface of the stopper part may have a shape corresponding to that of the outer peripheral surface of the stopper.

An outer peripheral surface of the stopper part may be provided with a first sealing groove recessed in an inner diameter direction.

The surface of the stator holder opposite to the outer peripheral surface of the stopper part may be provided with a second sealing groove recessed in the outer diameter direction.

According to another aspect of the present invention, there is provided a spindle motor including: a shaft including a body part and an extension part extended from an upper portion of the body part in an outer diameter direction; a sleeve rotatably supporting the shaft; a rotor coupled to the extension part so as to rotate together with the shaft and including a stopper part facing an outer peripheral surface of the sleeve; a stator holder including a fixation part coupled to the outer peripheral surface of the sleeve, a seating part on which a core having a coil wound therearound is seated, and a connection part connecting the fixation part and the seating part; and a base member fixedly coupled to an outer peripheral surface of the fixation part, wherein the connection part is disposed to face the stopper part, and the connection part and the stopper part have a labyrinth sealing part formed therebetween.

An upper surface of the connection part and a facing surface of the stopper part facing the upper surface of the connection part may be inclined upwardly in the outer diameter direction.

The connection part may include a sealing groove recessed inwardly from an upper surface thereof.

The facing surface of the stopper part facing the upper surface of the connection part may include a protrusion part protruding toward the sealing groove.

A size of a clearance between the sealing groove and the protrusion part may be larger than that of a clearance of the remaining portion between the upper surface of the connection part and the facing surface of the stopper part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is a semi cross-sectional view of a spindle motor according to another embodiment of the present invention;

FIG. 3 is a semi cross-sectional view of a spindle motor according to another embodiment of the present invention;

FIG. 4 is a semi cross-sectional view of a spindle motor according to another embodiment of the present invention;

FIG. 5 is a semi cross-sectional view of a spindle motor according to another embodiment of the present invention;

FIG. 6 is a semi cross-sectional view of a spindle motor according to another embodiment of the present invention; and

FIG. 7 is a semi cross-sectional view of a spindle motor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

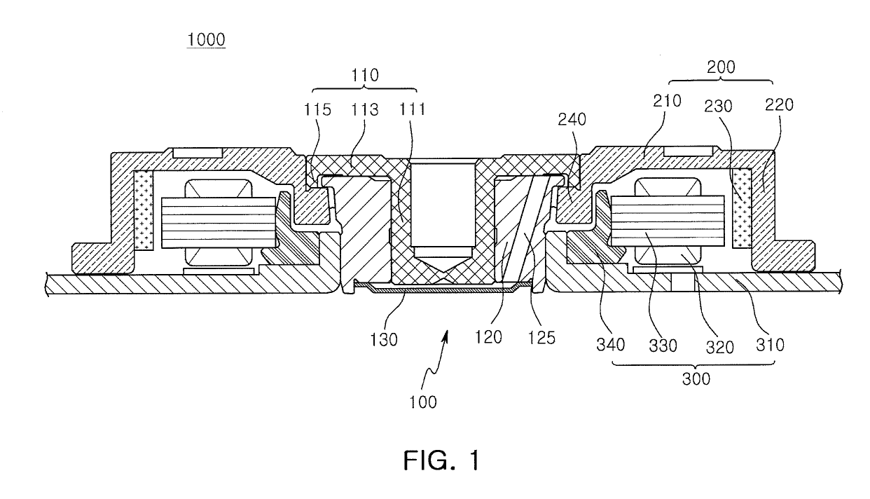

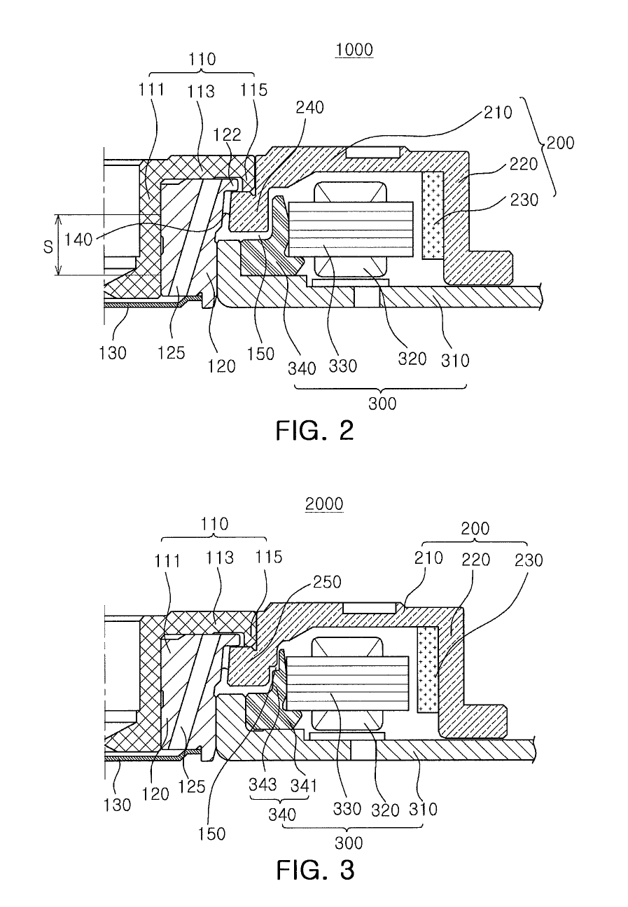

FIG. 1 is a schematic cross-sectional view of a spindle motor according to an embodiment of the present invention, and FIG. 2 is a semi cross-sectional view of the spindle motor according to the embodiment of the present invention.

Referring to FIGS. 1 and 2, the spindle motor 1000 according to the embodiment of the present invention may include a hydrodynamic bearing assembly 100, a stator 300, a fixed member, and a rotor 200, a rotating member.

Terms with respect to directions will be first defined. As viewed in FIG. 1, an axial direction refers to a vertical direction based on a shaft 110, and an outer diameter or inner diameter direction refers to a direction towards an outer edge of a rotor 200 based on the shaft 110 or a direction towards the center of the shaft 110 based on the outer edge of the rotor 200.

The hydrodynamic bearing assembly 100 may include a shaft 110, a sleeve 120, and a cover plate 130.

The shaft 110 may be a rotating member rotating together with the rotor 200.

The shaft 110 may include a body part 111 inserted into a shaft hole of the sleeve 120 and an extension part 113 extended from an upper end of the body part 111 in the outer diameter direction.

Here, the extension part 113 may be formed so that a distal end thereof is disposed outwardly of an outer peripheral surface of the sleeve 120 in the outer diameter direction, and the distal end of the extension part 113 may be coupled to the rotor 200.

Therefore, the extension part 113 and the rotor 200 may be coupled to each other outwardly of the outer peripheral surface of the sleeve 120 in the outer diameter direction.

In this case, the shaft 110 may further include a protrusion part 115 extended from the distal end of the extension part 113 in the axial direction so as to increase a coupling area with the rotor 200.

That is, since an outer peripheral surface of the extension part 113 and an outer peripheral surface and a bottom surface of the protrusion part 115 contact the rotor 200 to thereby be coupled to one another, the coupling area between the shaft 110 and the rotor 200 may be increased, and coupling force between the shaft 110 and the rotor 200 may be increased.

Therefore, the shaft 110 and the rotor 200 may be stably coupled, and as a result, rigidity of the spindle motor may be improved.

Here, in the case in which the shaft and the rotor are coupled at an upper side of an inner side end of the sleeve, a length of the sleeve in the axial direction maybe decreased by a coupled length of the shaft and the rotor in the axial direction.

The reason is that there is a limitation in increasing the length of the sleeve in the axial direction in terms of miniaturization and thinness of the spindle motor.

That is, since there is a limitation in increasing a total height of the spindle motor, when the shaft and the rotor are coupled at the upper side of the inner side end of the sleeve, the length of the sleeve in the axial direction may not be sufficiently secured.

However, when the length of the sleeve in the axial direction is decreased, a bearing span length S is decreased by the decreased length thereof, such that radial dynamic pressure for supporting rotation of the shaft may be weakened.

The bearing span length S refers to a distance between points at which the highest pressure is generated by a radial dynamic pressure part.

Since the longer the bearing span length is, the more the rotation of the shaft is stably supported, in the case in which the bearing span length S be decreased, eccentricity may be generated at the time of the rotation of the shaft, and bearing rigidity may be deteriorated.

Therefore, in the spindle motor 1000 according to the embodiment of the present invention, in order to secure bearing rigidity while implementing the miniaturization and thinness of the spindle motor, the shaft 110 and the rotor 200 may be coupled to each other outwardly of the outer peripheral surface of the sleeve 120 in the outer diameter direction.

Therefore, the length of the sleeve 120 in the axial direction may be increased in a state in which the total height of the spindle motor is not changed.

In addition, the total height of the spindle motor is decreased, but the length of the sleeve 12.0 in the axial direction may be increased, by decreasing a thickness of the extension part 113 extended from the upper end of the body part 111 of the shaft 110.

Therefore, the spindle motor 1000 according to the embodiment of the present invention have increased bearing span length S while implementing miniaturization and thinness thereof, such that the bearing rigidity may be improved.

The sleeve 120 may support the shaft 110 so that the shaft 110 may rotate and be formed by forging Cu or Al or sintering Cu-Fe based alloy powders or SUS based powders.

Here, the shaft 110 may be inserted into a shaft hole of the sleeve so as to have a micro clearance therewith. The micro clearance may be filled with a lubricating fluid, and the rotation of the shaft 110 may be more smoothly supported by a radial dynamic pressure groove (not shown) formed in at least one of an outer circumferential surface of the shaft 110 and an inner circumferential surface of the sleeve 120.

The radial dynamic pressure groove (not shown) may be formed in an inner peripheral surface of the sleeve 120, an inner portion of the shaft hole of the sleeve 120, and generate pressure so that the shaft 110 may smoothly rotate in a state in which the shaft 110 is spaced apart from the inner peripheral surface of the sleeve 120 by a predetermined interval at the time of rotation of the shaft 110.

However, the radial dynamic pressure groove (not shown) is not limited to being formed in the inner peripheral surface of the sleeve 120 as described above, but may also be formed in an outer peripheral surface of the shaft 110. In addition, the number of radial dynamic pressure grooves is not limited.

The radial dynamic pressure groove (not shown) may have any one of a herringbone pattern, a spiral pattern, and a helical pattern. However, the radial dynamic pressure groove may have any shape as long as radial dynamic pressure may be generated.

In addition, a thrust dynamic pressure groove (not shown) may be formed in at least one of an upper surface of the sleeve 120 and one surface of the extension part of the shaft facing the upper surface of the sleeve 120, and the shaft 110 may rotate together with the rotor 200 in a state in which a predetermined floating force is secured by the thrust dynamic pressure groove (not shown).

Here, the thrust dynamic pressure groove (not shown) may have a herringbone pattern, a spiral pattern, or a helical pattern, similar to the radial dynamic pressure groove (not shown). However, the thrust dynamic pressure groove (not shown) is not necessarily limited to having the above-mentioned shape, but may have any shape as long as the thrust dynamic pressure may be provided.

Further, in the sleeve 120, at least one bypass channel 125 allowing upper and lower portions of the sleeve 120 to be in communication with each other may be formed.

The bypass channel 125 may disperse pressure of the lubricating fluid to maintain a balance in the pressure and may move air bubbles, or the like, present in the lubricating fluid so as to be discharged by circulation.

The cover plate 130 may be coupled to the sleeve 120, having a clearance between the cover plate 130 and a lower portion of the sleeve 120.

The cover plate 130 may receive the lubricating fluid in the clearance formed between the cover plate 130 and the sleeve 120 to support a lower surface of the shaft 110.

In this case, as a method for fixing the cover plate 130, various methods such as a welding method, a caulking method, a bonding method, or the like, may be used, which may be optionally applied according to a structure and a process of a product.

The stator 300 may include a coil 320, a core 330, a base member 310, and a stator holder 340.

The stator 300 is a fixed structure including the core 330 having the coil 320 wound therearound, wherein the coil 320 generates electromagnetic force having a predetermined magnitude at the time of application of power.

The core 330 may be fixedly disposed on an upper portion of the base member 310 on which a printed circuit board (not shown) having pattern circuits printed thereon is provided, a plurality of coil holes having a predetermined size may be formed to penetrate through the base member 310 so as to expose the coil 320 downwardly in an upper surface of the base member 310 corresponding to the core 330 having the coil 320 wound therearound, and the coil 320 may be electrically connected to the printed circuit board (not shown) in order to supply external power.

Here, the base member 310 may be manufactured using aluminum (Al) in a die-casting scheme or be manufactured by performing plastic working (for example, press working) on a steel sheet.

The stator holder 340 may be fixedly coupled to the base member 310, and the core 330 may be seated on one surface of the stator holder 340.

More specifically, one surface of the stator holder 340 may be formed to be stepped, and the core 330 may be seated on a stepped portion.

The rotor 200 is a rotational structure provided to be rotatable with respect to the stator 300 and may include an annular ring shaped magnet 230 on an inner peripheral surface thereof so as to correspond to the core 330, having a predetermined interval therebetween.

Here, the rotor 200 may include a disk part 210 coupled to the extension part of the shaft 110 to be fixed thereto and a magnet support part 220 extended from the disk part 210 to be bent downwardly in the axial direction to thereby support the magnet 230.

In addition, as the magnet 230, a permanent magnet generating magnetic force having predetermined strength by alternately magnetizing an N pole and an S pole thereof in a circumferential direction may be used.

Here, rotational driving of the rotor 200 will be schematically described. When power is supplied to the coil 320 wound around the core 330, driving force capable of rotating the rotor 200 by electromagnetic interaction between the magnet 230 and the core 330 having the coil 320 wound therearound may be generated.

Therefore, the rotor 220 rotates, such that the shaft 110 to which the rotor 200 is fixedly coupled may also rotate together with the rotor 200.

The rotor may be provided with a stopper part 240 extended from the disk part 210 so as to be disposed to face the outer peripheral surface of the sleeve 120.

An oil sealing part 140 may be formed between an inner peripheral surface of the stopper part 240 and the outer peripheral surface of the sleeve 120 so that the lubricating fluid is sealed thereby.

The inner peripheral surface of the stopper part 240 and the outer peripheral surface of the sleeve 120 facing the inner peripheral surface of the stopper part 240 may be inclined so that the lubricating fluid is sealed.

More specifically, the outer peripheral surface of the sleeve 120 and the inner peripheral surface of the stopper part 240 may be inclined downwardly in the inner diameter direction as shown in FIG. 2.

Here, the upper portion of the sleeve 120 may be provided with a flange part 122 protruding in the outer diameter direction, and a lower surface of the flange part 122 may face a portion of an upper surface of the stopper part.

Therefore, in the case in which the shaft 110 and the rotor 200, which are the rotating members, are excessively floated, the portion of the upper surface of the stopper part 240 is caught by the lower surface of the flange part 122, thereby preventing the rotating members from being excessively floated.

Meanwhile, a lower surface and an outer peripheral surface of the stopper part 240 may face the stator holder 340.

A predetermined clearance may be formed between the lower surface and the outer peripheral surface of the stopper part 240 and surfaces of the stator holder 340 facing the lower surface and the outer peripheral surface of the stopper part 240 to form a labyrinth sealing part 150.

Therefore, a sealing effect may be improved by the labyrinth sealing part 150.

More specifically, the labyrinth sealing part 150 may suppress air containing the lubricating fluid evaporated from the oil sealing part 140 from being leaked to the outside to prevent the lubricating fluid from being decreased and prevent foreign materials from being introduced from the outside.

FIG. 3 is a semi cross-sectional view of a spindle motor according to another embodiment of the present invention.

Referring to FIG. 3, since the spindle motor 2000 according to another embodiment of the present invention is the same as the spindle motor 1000 according to the embodiment of the present invention described above except for a stator holder 340 and a stopper part 250, a description thereof except for the stator holder 340 and the stopper 250 will be omitted.

The stator holder 340 may be coupled to a base member 310 and include a seating part 341 for allowing a core 330 having a coil 320 wound therearound to be seated thereon and a support part 343 extended from the seating part 341 in the axial direction.

The core 330 may be seated on and fixed to a step formed by the support part 343 and the seating part 341.

Meanwhile, an inner peripheral surface of the support part 343 may be disposed to face an outer peripheral surface of the stopper part 250, having a predetermined interval therebetween.

In addition, the outer peripheral surface of the stopper part 250 may be partially depressed in the inner diameter direction to be stepped, and the inner peripheral surface of the support part 343 facing the outer peripheral surface of the stopper part 250 may also be stepped so as to correspond to a shape of the outer peripheral surface of the stopper part 250.

Here, a labyrinth sealing part 150 may be provided between the outer peripheral surface of the stopper part 250 and the inner peripheral surface of the support part 343.

A pressure change effect may be significantly increased by the labyrinth sealing part 150, and as a result, a sealing effect may be improved.

That is, the labyrinth sealing part 150 may suppress air containing the lubricating fluid evaporated from an oil sealing part 140 from being leaked to the outside to prevent the lubricating fluid from being decreased and prevent foreign materials from being introduced from the outside.

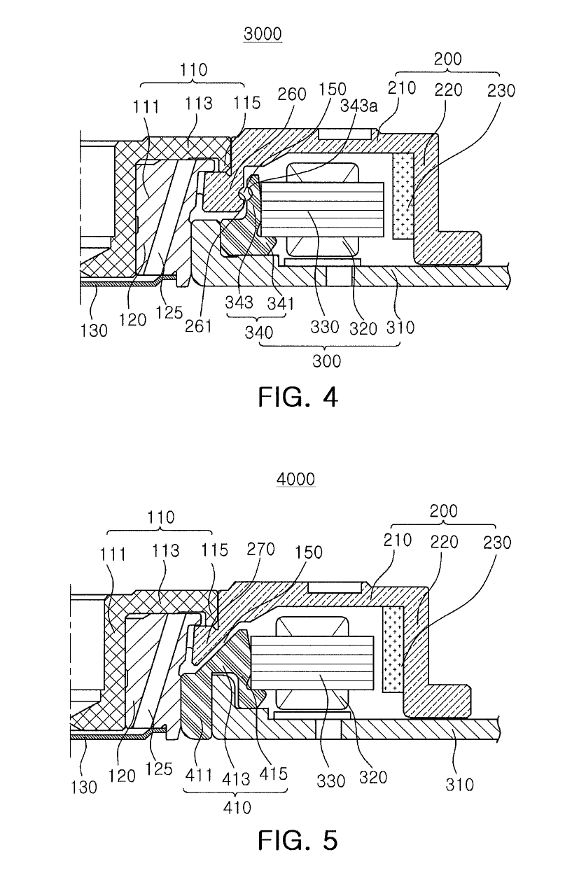

FIG. 4 is a semi cross-sectional view of a spindle motor according to another embodiment of the present invention.

Referring to FIG. 4, since the spindle motor 3000 according to another embodiment of the present invention is the same as the spindle motor 2000 according to the embodiment of the present invention described above except for a labyrinth sealing part 150, a description thereof except for the labyrinth sealing part 150 will be omitted.

A labyrinth sealing part 150 may be provided between an outer peripheral surface of a stopper part 260 and an inner peripheral surface of a support part 343.

To this end, the outer peripheral surface of the stopper part 260 may be provided with a first sealing groove 261 depressed in the inner diameter direction, wherein the first sealing groove 261 may have a hemispherical cross-sectional shape.

In addition, the inner peripheral surface of the support part 343 facing the outer peripheral surface of the stopper part 260 may be provided with a second sealing groove 343a depressed in the outer diameter direction, wherein the second sealing groove 343a may have a hemispherical cross-sectional shape.

However, the shapes of the first and second sealing grooves 261 and 343a formed in the stopper part 260 and the support part 343 are not limited to the hemispherical cross-sectional shape, but may have any shapes as long as a labyrinth sealing effect may be expected.

An expanded space may be formed between the outer peripheral surface of the stopper part 260 and the inner peripheral surface of the support part 343 by the first and second sealing grooves 261 and 343a, and the space may serve as a labyrinth sealing part.

Therefore, when air introduced into a relatively narrow space is introduced into the expanded space, air velocity may be rapidly decreased, such that the sealing effect may be improved.

That is, the labyrinth sealing part 150 may suppress air containing the lubricating fluid evaporated from an oil sealing part 140 from being leaked to the outside to prevent the lubricating fluid from being decreased and prevent foreign materials from being introduced from the outside.

FIG. 5 is a semi cross-sectional view of a spindle motor according to another embodiment of the present invention.

Referring to FIG. 5, since the spindle motor 4000 according to another embodiment of the present invention is the same as the spindle motor 1000 according to the embodiment of the present invention described above except for a stopper part 270 and a stator holder 410, a description thereof except for the stopper part 270 and the stator holder 410 will be omitted.

The stator holder 410 may include a fixation part 411 coupled to a sleeve 120 and a base member 310, a seating part 415 on which a core 330 is seated, and a connection part 413 connecting the fixation part 411 and the seating part 415.

The fixation part 411 may have an inner peripheral surface coupled to an outer peripheral surface of the sleeve 120 and an outer peripheral surface coupled to the base member 310.

An outer peripheral surface of the seating part 415 may be stepped, and the core 330 may be seated on a stepped portion.

The connection part 413 may be a configuration for connecting an upper end of the fixation part 411 and the seating part 415, and an upper surface of the connection part 413 may face the stopper part 270.

A labyrinth sealing part 150 may be formed between the upper surface of the connection part 413 and a surface of the stopper part 270 facing the upper surface of the connection part 413.

The upper surface of the connection part 413 and the surface of the stopper part 270 facing the upper surface of the connection part 413 may be inclined, and more specifically, and may be inclined upwardly in the outer diameter direction.

Therefore, a length of the labyrinth sealing part 150 may be increased, and as a result, the sealing effect may be increased.

FIG. 6 is a semi cross-sectional view of a spindle motor according to another embodiment of the present invention.

Referring to FIG. 6, since the spindle motor 5000 according to another embodiment of the present invention is the same as the spindle motor 4000 according to the embodiment of the present invention described above except for a labyrinth sealing part 150, a description thereof except for the labyrinth sealing part 150 will be omitted.

The labyrinth sealing part 150 may be formed between an upper surface of a connection part 513 and a facing surface of a stopper part 280 facing the upper surface of the connection part 513, and the upper surface of the connection part 513 and the facing surface of the stopper part 270 facing the upper surface of the connection part 513 may be inclined upwardly in the outer diameter direction.

Here, the connection part 513 provided in a stator holder 510 may include a sealing groove 513a depressed inwardly from the upper surface of the connection part 513.

Further, the facing surface of the stopper part 280 facing the upper surface of the connection part 513 may include a protrusion part 281 protruding toward the sealing groove 513a.

A size of a clearance between the sealing groove 513a and the protrusion part 281 may be larger than that of a clearance of the remaining portion between the upper surface of the connection part 513 and the facing surface of the stopper part 280.

Therefore, a length of the labyrinth sealing part 150 may be increased due to a configuration in which the upper surface of the connection part 513 and the facing surface of the stopper part 280 are inclined, and the sealing effect may be significantly increased due to the relatively large clearance between the sealing groove 513a and the protrusion part 281.

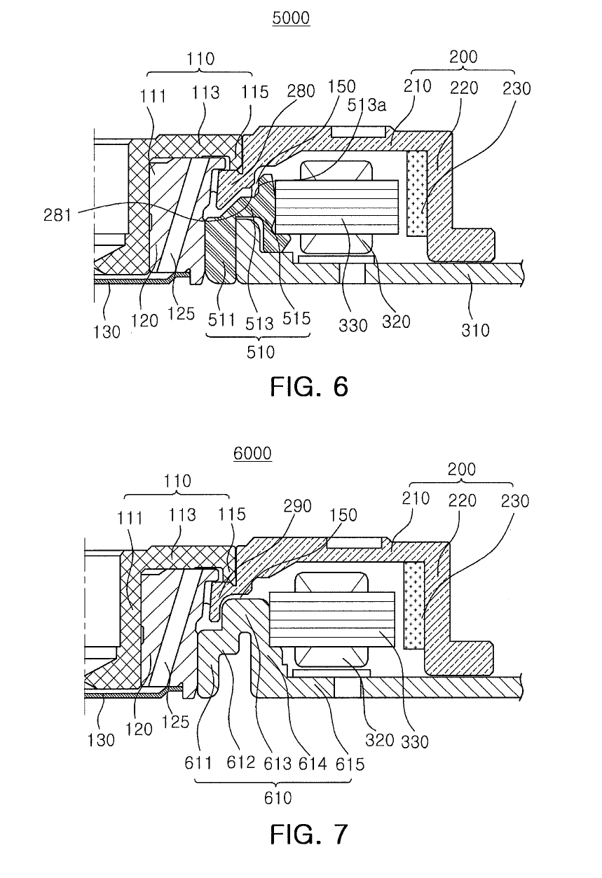

FIG. 7 is a semi cross-sectional view of a spindle motor according to another embodiment of the present invention.

Referring to FIG. 7, since the spindle motor 6000 according to another present embodiment of the present invention is the same as the spindle motor 1000 according to the embodiment of the present invention described above except for a base member 610 and a stopper part 290, a description thereof except for the base member 610 and the stopper 290 will be omitted.

The base member 610 of the spindle motor 6000 according to another embodiment of the present invention may include a fixation part 611 coupled to a sleeve 120 to fix the sleeve 120, an extension part 612 extended from an upper end of the fixation part 611 in the outer diameter direction, a connection part 613 extended upwardly from the extension part 612 in the axial direction to be bent from one end thereof in the outer diameter direction, a seating part 614 extended downwardly from the connection part 613 in the axial direction and having an outer peripheral surface stepped so that a core is seated thereon, and a body part 615 extended from the seating part 614 in the outer diameter direction.

The connection part 613 may be a configuration for connecting the extension part 612 and the seating part 614, and an upper surface of the connection part 613 may be flat.

The stopper part 290 may be formed to face an inner peripheral surface and the upper surface of the connection part 613, and a labyrinth sealing part 150 may be formed between the stopper part 290 and the connection part 613.

The labyrinth sealing part 150 may suppress air containing the lubricating fluid evaporated from an oil sealing part 140 from being leaked to the outside to prevent the lubricating fluid from being decreased and prevent foreign materials from being introduced from the outside.

As set forth above, in the spindle motor according to the embodiments of the present invention, the rigidity thereof may be improved, the bearing span length may be increased while satisfying the demand for miniaturization and thinness, and the leakage of the lubricating fluid and the introduction of the foreign materials may be simultaneously prevented by including the labyrinth sealing part.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft including a body part and an extension part extended from an upper portion of the body part in an outer diameter direction;
a sleeve rotatably supporting the shaft; and
a rotor rotating together with the shaft and including a stopper part facing an outer peripheral surface of the sleeve,
wherein the extension part and the rotor are coupled to each other outwardly of the outer peripheral surface of the sleeve in the outer diameter direction.

2. The spindle motor of claim 1, wherein the shaft further includes a protrusion part extended from a distal end of the extension part in an axial direction, and the extension part and the protrusion part are coupled to the rotor.

3. The spindle motor of claim 1, wherein the rotor includes a disk part coupled to the extension part, and the stopper part is extended from the disk part.

4. The spindle motor of claim 1, wherein the outer peripheral surface of the sleeve and an inner peripheral surface of the stopper part are inclined downwardly in an inner diameter direction.

5. The spindle motor of claim 1, wherein the outer peripheral surface of the sleeve and an inner peripheral surface of the stopper part are inclined downwardly in the outer diameter direction.

6. The spindle motor of claim 1, further comprising:
a base member fixedly coupled to the sleeve; and
a stator holder fixed to the base member and having a core seated thereon, the core having a coil wound therearound.

7. The spindle motor of claim 6, wherein an outer peripheral surface of the stopper part and a surface of the stator holder opposite to the outer peripheral surface of the stopper part include a labyrinth sealing part formed therebetween.

8. The spindle motor of claim 6, wherein an outer peripheral surface of the stopper part is stepped in an inner diameter direction, and the surface of the stator holder opposite to the outer peripheral surface of the stopper part has a shape corresponding to that of the outer peripheral surface of the stopper.

9. The spindle motor of claim 6, wherein an outer peripheral surface of the stopper part is provided with a first sealing groove recessed in an inner diameter direction.

10. The spindle motor of claim 6, wherein the surface of the stator holder opposite to the outer peripheral surface of the stopper part is provided with a second sealing groove recessed in the outer diameter direction.

11. A spindle motor comprising:
a shaft including a body part and an extension part extended from an upper portion of the body part in an outer diameter direction;
a sleeve rotatably supporting the shaft;
a rotor coupled to the extension part so as to rotate together with the shaft and including a stopper part facing an outer peripheral surface of the sleeve;
a stator holder including a fixation part coupled to the outer peripheral surface of the sleeve, a seating part on which a core having a coil wound therearound is seated, and a connection part connecting the fixation part and the seating part; and
a base member fixedly coupled to an outer peripheral surface of the fixation part,
wherein the connection part is disposed to face the stopper part, and the connection part and the stopper part have a labyrinth sealing part formed therebetween.

12. The spindle motor of claim 11, wherein an upper surface of the connection part and a facing surface of the stopper part facing the upper surface of the connection part are inclined upwardly in the outer diameter direction.

13. The spindle motor of claim 11, wherein the connection part includes a sealing groove recessed inwardly from an upper surface thereof.

14. The spindle motor of claim 13, wherein the facing surface of the stopper part facing the upper surface of the connection part includes a protrusion part protruding toward the sealing groove.

15. The spindle motor of claim 14, wherein a size of a clearance between the sealing groove and the protrusion part is larger than that of a clearance of the remaining portion between the upper surface of the connection part and the facing surface of the stopper part.
